(19) United States
(12) Patent Application Publication
(10) Pub. No.: US 2023/0415980 A1
(43) Pub. Date: Dec. 28, 2023

(54) IMPERCEPTIBLE SLIPPING DEVICE AND TRASHCAN WITH SAME

(71) Applicant: Jiangmen Jinlong High Technology Industrial Co., Ltd., Jiangmen (CN)

(72) Inventors: Jinsheng LIAO, Jiangmen (CN); Zhaofa TANG, Jiangmen (CN)

(21) Appl. No.: 18/178,631

(22) Filed: Mar. 6, 2023

(30) Foreign Application Priority Data
Jun. 27, 2022 (CN) 202221627753.1

(51) Int. Cl. B65F 1/16; E05F 15/611; B65F 1/02

(52) U.S. Cl. CPC B65F 1/1638; E05F 15/611; B65F 1/02; E05Y 2201/216; E05Y 2201/232; E05Y 2201/266; E05Y 2201/434; E05Y 2800/40; E05Y 2900/602

(57) ABSTRACT

Disclosed are an imperceptible slipping device and a trashcan with the same. the imperceptible slipping device may include a first connecting member and a second connecting member, where the first connecting member is used for being connected with an output shaft of a motor, the first connecting member is convexly provided with a first connecting part, and an outer side of the first connecting part is provided with an abutting member; and the second connecting member is used for being connected with a rotating part, the second connecting member is provided with a first plugging hole for accommodating the first connecting part, the first connecting part is plugged into the first plugging hole, and the abutting member is in interference fit with the first plugging hole.

### CROSS-REFERENCE TO RELATED APPLICATION

This application is filed on the basis of Chinese Patent Application No. 202221627753.1 filed on Jun. 27, 2022, and claims priority to the Chinese patent application, the entire contents of which are incorporated herein by reference.

### TECHNICAL FIELD

The present disclosure relates to the field of articles for daily use, and more particularly, to an imperceptible slipping device and a trashcan with the same.

### BACKGROUND

An upper cover of an electric trashcan can be automatically opened. When there is resistance preventing the upper cover from being opened, overloading occurs in a motor. At present, the motor is generally provided with a slipping device to prevent the motor from overloading, however, when taking effects, the present existing slipping device generates relatively large noise, which influences the user experience.

### SUMMARY

The present disclosure aims to address at least one of the technical problems existing in the prior art. Therefore, the present disclosure provides an imperceptible slipping device and a trashcan with the same, which can prevent a motor from slipping and overloading, and meanwhile reduce noise during slipping, and improve the user experience.

According to a first aspect, an embodiment of the present disclosure provides an imperceptible slipping device, including a first connecting member and a second connecting member, where the first connecting member is used for being connected with an output shaft of a motor, the first connecting member is convexly provided with a first connecting part, and an abutting member is disposed outside the first connecting part; and the second connecting member is used for being connected with a rotating part, the second connecting member is provided with a first plugging hole for accommodating the first connecting part, the first connecting part is plugged into the first plugging hole, and the abutting member is in interference fit with the first plugging hole.

The imperceptible slipping device according to the embodiment of the present disclosure, at least has the following advantages that: the output shaft of the motor is connected with the first connecting member, the rotating part is connected with the second connecting member, the first connecting part is plugged with a positioning hole, and by means of interference fit between the abutting member and the positioning hole, and by using friction between the abutting member and a sidewall of positioning hole, the motor drives the rotating part to rotate through the imperceptible slipping device, so that a cover body of a trashcan can be opened or closed automatically. When the cover body is blocked, and external force exceeds the friction, the first connecting member and the second connecting member rotate relative to each other, so that the motor idles and is avoided from overloading, and at the same time, noise is reduced by friction, thereby improving the user experience.

According to some embodiments of the present disclosure, an outer side of the first connecting part is provided with a positioning groove along a circumferential direction, and the abutting member is sleeved in the positioning groove.

According to some embodiments of the present disclosure, the first connecting part is provided with a positioning hole at one end towards the first plugging hole, a positioning column is arranged in the first plugging hole, and the positioning column is in plugging fit with the positioning hole.

According to some embodiments of the present disclosure, the positioning hole is provided with a first guiding part at one end towards the second connecting member, the positioning column is provided with a second guiding part at one end towards the first connecting member, the first guiding part matches with the second guiding part, so that the positioning column is guided into the positioning hole.

According to some embodiments of the present disclosure, the first connecting member is outwards and convexly provided with a positioning part along a radial direction, and the positioning part abuts against the second connecting member.

According to some embodiments of the present disclosure, an outer edge of the positioning part is flush with that of the second connecting member.

The trashcan according to embodiments in a second aspect of the present disclosure, comprises the imperceptible slipping device of the embodiments of the first aspect of the present disclosure.

According to the second aspect, an embodiment of the present disclosure provides a trashcan, a first connecting member drives a second connecting member to move by means of friction between an abutting member and the a plugging hole, so as to implement a cover body movement driven by a motor; when external force blocks the cover body from moving and exceeds the friction between the abutting member and the first plugging hole, the first connecting member and the second connecting member rotate relative to each other, so that an output shaft of the motor and the rotating part slip over each other, the motor is prevented from overloading, and meanwhile noise during slipping is reduced by friction, thereby improving the user experience.

According to some embodiments of the present disclosure, the trashcan further includes an upper cover component and a barrel body, the upper cover component includes a motor component, a cover body and a mounting body, the motor component and the rotating part are both arranged in the mounting body, the cover body is connected with the rotating part, an output shaft of the motor component is connected with the first connecting member, and the rotating part is connected with the second connecting member.

According to some embodiments of the present disclosure, the second connecting member is provided with a second plugging hole along an axial direction of the second connecting member at one end towards the rotating part, the rotating part is provided with a second connecting part which matches with the second plugging hole, and the second connecting part is plugged with the second plugging hole, so that the second connecting member can drive the rotating part to rotate.

According to some embodiments of the present disclosure, the second connecting part is outwards and convexly provided with a key position along an radial direction of the rotating part, a sidewall of the second plugging hole is provided with a key groove by extending outwards along the radial direction of the second connecting member, and the key position matches with the key groove.

Additional aspects and advantages of the present disclosure will be partially described in the following description, and some of them will become obvious from the following description, or be understood from practice of the present disclosure.

### BRIEF DESCRIPTION OF THE DRAWINGS

The above and/or additional aspects and advantages of the present disclosure will become apparent and easy to understand from the description of embodiments in combination with the following drawings, wherein:

FIG. 1 is a section view of a trashcan of embodiments in a second aspect of the present disclosure;

FIG. 2 is a partially enlarged schematic diagram of A in FIG. 1;

FIG. 3 is a top view of a trashcan of embodiments in a second aspect of the present disclosure;

FIG. 4 is a schematic diagram of a second connecting member in an imperceptible slipping device of embodiments in a first aspect of the present disclosure;

FIG. 5 is a schematic diagram of a rotating part in a trashcan of embodiments in a second aspect of the present disclosure;

FIG. 6 is a schematic diagram of another implementation of a trashcan of embodiments in a second aspect of the present disclosure; and

FIG. 7 is a partially enlarged schematic diagram of B in FIG. 6.

### REFERENCE NUMERALS

motor component 110, first connecting member 121, second connecting member 122, abutting member 123, positioning part 124, positioning hole 125, positioning column 126, second guiding part 1261, first connecting part 127, first guiding part 1271, positioning groove 128, second plugging hole 1291, key groove 1292, rotating part 130, second connecting part 131, key position 132; upper cover component 200, cover body 201, mounting body 202; barrel body 300; and connecting rod component 400.

### DETAILED DESCRIPTION

Embodiments of the present disclosure are described in detail below. Examples of the embodiments are shown in the attached drawings, in which the same or similar labels throughout represent the same or similar elements or elements with the same or similar functions. The embodiments described below with reference to the attached drawings are exemplary and are only used to explain the present disclosure, but cannot be understood as a limitation to the present disclosure.

In the description of the present disclosure, it needs to be understood that the orientation description, for example, the orientation or position relationship indicated by up, down, front, back, left, right, etc. is based on the orientation or position relationship shown in the drawings, which is only for the convenience of describing the present disclosure and simplifying the description, rather than indicating or implying that a device or element referred to must have a specific orientation, be constructed and operated in a specific orientation, therefore, it cannot be understood as a limitation to the present disclosure.

In the description of the present disclosure, several means one or more, and many means more than two, more than, less than, beyond and the like that are understood to exclude the number, while above, below, within and the like are understood to include the number. First and second are described only for the purpose of distinguishing the technical features, it cannot be understood as indicating or implying the relative importance or implying the quantity of the indicated technical features or implying the order of the indicated technical features.

In the description of the present disclosure, unless otherwise specified, terms such as setting, installation, connection, etc. should be generally understood, and those skilled in the art can reasonably determine the specific meaning of the above terms in the present disclosure in combination with the specific content of the technical solution.

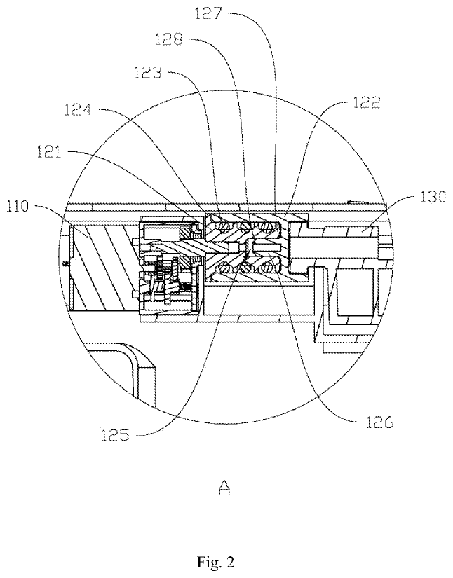

Referring to FIG. 2, an imperceptible slipping device according to embodiments of the first aspect of the present disclosure includes a first connecting member 121 and a second connecting member 122, where the first connecting member 121 is used for being connected with an output shaft of a motor, the first connecting member 121 is convexly provided with a first connecting part 127, and an abutting member 123 is disposed outside the first connecting part 127; and the second connecting member 122 is used for being connected with a rotating part 130, the second connecting member 122 is provided with a first plugging hole for accommodating the first connecting part 127, the first connecting part 127 is plugged into the first plugging hole, and the abutting member 123 is in interference fit with the first plugging hole. It should be noted that, the abutting member 123 may be a rubber ring.

The output shaft of the motor is connected with the first connecting member 121, so that when the motor rotates, the first connecting member 121 is driven to rotate, the rotating part 130 is connected with the second connecting member 122, the first connecting part 127 is plugged with a positioning hole 125, and by means of interference fit between the abutting member 123 and the positioning hole 125, friction between the abutting member 123 and a sidewall of the positioning hole 125 is increased, and by using the friction between the abutting member 123 and the sidewall of the positioning hole 125, the motor drives the rotating part 130 to rotate through the imperceptible slipping device, so that a cover body 201 of a trashcan can be opened or closed automatically.

Referring to FIG. 2, when the cover body 201 is blocked, and external force which blocks the cover body 201 from rotating exceeds the friction, the first connecting member 121 and the second connecting member 122 rotate relative to each other, the first connecting member 121 and the second connecting member 122 slip over each other, and at this time the motor idles and is avoided from overloading. Compared with common slipping implemented by dislocation, slipping by friction can effectively reduce slipping noise, and improve the user experience. In addition, it can be understood that, damping oil can be added into the positioning hole 125, which can further reduce noise generated during friction between the abutting member 123 and the sidewall of the positioning hole 125.

It can be understood that, referring to FIG. 2, an outer side of the first connecting part 127 is provided with a positioning groove 128 along a circumferential direction, and the abutting member 123 is sleeved within the positioning groove 128. The positioning groove 128 is arranged to limit movement of the abutting member 123 along an axial direction of the first connecting part 127, so that the abutting member 123 is avoided from offset when the first connecting member 121 drives the second connecting member 122 to rotate, the friction between the abutting member 123 and a sidewall of the first plugging hole is avoided from being reduced, so the friction between the abutting member 123 and the sidewall of the first plugging hole is kept stable, a slipping critical value between the first connecting member 121 and the second connecting member 122 is kept stable, and a protective effect on the motor is improved.

It can be also understood that, the first plugging hole can be filled with damping oil, so that while the friction between the abutting member 123 and the sidewall of the first plugging hole is increased, generated noise is reduced, and a silent effect of the imperceptible slipping device is improved.

It can be understood that, referring to FIG. 2, the first connecting part 127 is provided with the positioning hole 125 at one end towards the first plugging hole, a positioning column 126 is arranged in the first plugging hole, and the positioning column 126 is in plugging fit with the positioning hole 125, so that the first connecting part 127 can be plugged into the first plugging hole more smoothly, at the same time shaking of the first connecting part 127 in the first plugging hole is reduced, it is avoided that different places of the abutting member 123 bear different friction due to uneven pressure, and reduction of the protection effect of the imperceptible slipping device is avoided.

It can be understood that, referring to FIG. 2, the positioning hole 125 is provided with a first guiding part 1271 at one end towards the second connecting member 122, the positioning column 126 is provided with a second guiding part 1261 at one end towards the first connecting member 121, the first guiding part 1271 matches with the second guiding part 1261, so that the positioning column 126 is guided into the positioning hole 125. The first guiding part 1271 is guided by the second guiding part 1261, so that the positioning column 126 is plugged into the positioning hole 125 more smoothly, and the assembling efficiency is improved.

It can be understood that, referring to FIG. 2, the first connecting member 121 is outwards and convexly provided with a positioning part 124 along a radial direction, and the positioning part 124 abuts against the second connecting member 122, so that after the first connecting part 127 is plugged into the first plugging hole, the positioning part 124 abuts against the second connecting member 122 to restrict the stroke of the first connecting part 127, and achieve positioning of the first connecting part 127 in the first plugging hole, and at the same time, the first connecting member 121 is avoided from being wholly plugged into the first plugging hole, so that the first connecting member 121 can be conveniently separated from the second connecting member 122.

It can be understood that, referring to FIG. 2, an outer edge of the positioning part 124 is flush with that of the second connecting member 122, so that the imperceptible slipping device has a beautiful appearance.

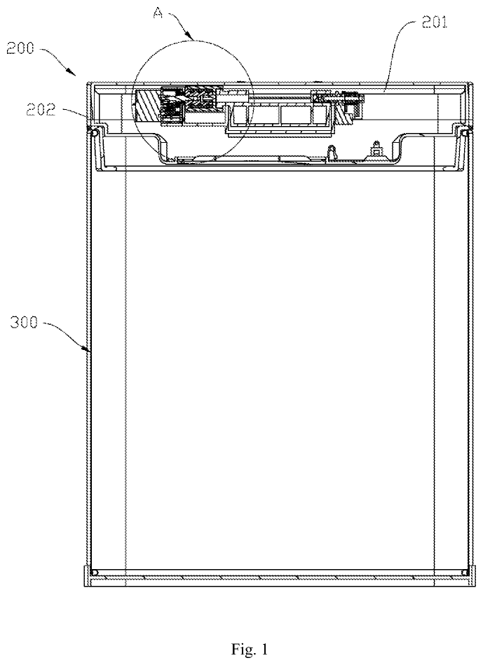

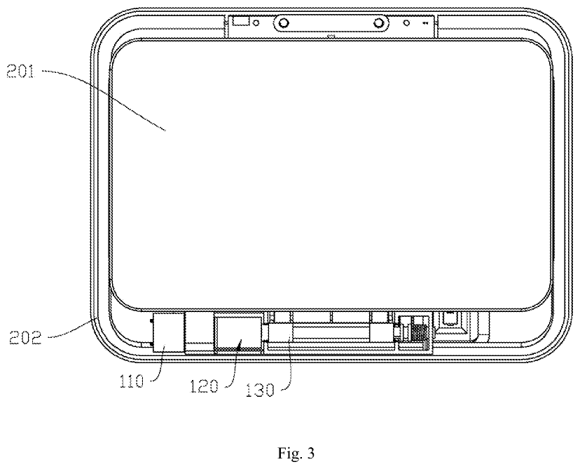

Referring to FIG. 1 to FIG. 3, a trashcan of embodiments in the second aspect of the present disclosure includes the imperceptible slipping device of embodiments in the first aspect of the present disclosure. The first connecting member 121 drives the second connecting member 122 to move by means of the friction between the abutting member 123 and the first plugging hole, so that the motor drives the cover body 201 to move; when external force blocks the cover body 201 from moving and exceeds the friction between the abutting member 123 and the first plugging hole, the first connecting member 121 and the second connecting member 122 rotate relative to each other, so that the output shaft of the motor and the rotating part 130 slip over each other, the motor is prevented from overloading, and meanwhile by replacing dislocation slipping with friction slipping, noise during slipping is reduced, and the user experience is improved.

It can be understood that, referring to FIG. 1 to FIG. 3, the trashcan further includes an upper cover component 200 and a barrel body 300, the upper cover component 200 includes a motor component 110, the cover body 201 and a mounting body 202, the mounting body 202 is arranged at an upper end of the barrel body 300, the motor component 110 and the rotating part 130 are both arranged in the mounting body 202, the cover body 201 is connected with the rotating part 130, an output shaft of the motor component 110 is connected with the first connecting member 121, and the rotating part 130 is connected with the second connecting member 122. The motor component 110 includes the motor, the output shaft of the motor is connected with the first connecting member 121, the rotating part 130 is connected with the second connecting member 122, the motor drives the rotating part 130 to rotate by means of matching of the first connecting member 121 with the second connecting member 122, thereby driving the cover body 201 to rotate automatically, and achieving automatic opening or automatic closing of a trashcan opening.

It should be noted that, the motor, the imperceptible slipping device and the rotating part 130 are compactly connected along the axial direction, so as to reduce shaking among the motor, the imperceptible slipping device and the rotating part 130 along the axial direction, reduce noise during operation, and at the same time make the structure compact and save the space.

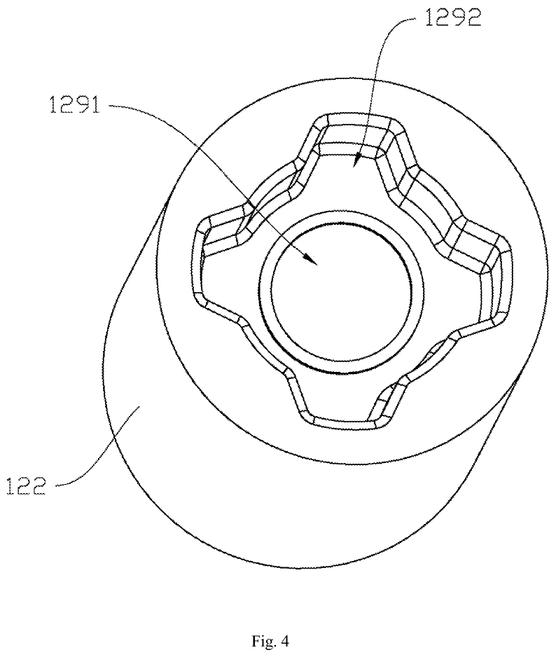

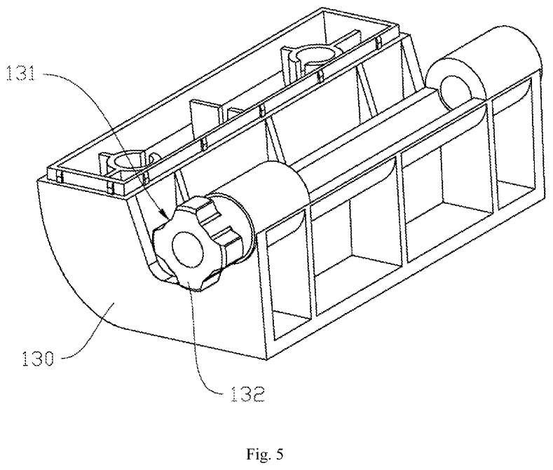

It can be understood that, referring to FIG. 2, FIG. 4 and FIG. 5, the second connecting member 122 is provided with a second plugging hole 1291 along the axial direction of the second connecting member 122 at one end towards the rotating part 130, the rotating part 130 is provided with a second connecting part 131 which matches with the second plugging hole 1291, and the second connecting part 131 is plugged with the second plugging hole 1291, so that the second connecting member 122 can drive the rotating part 130 to rotate. By means of plugging of the second connecting part 131 with the second plugging hole 1291, the imperceptible slipping device can drive the rotating part 130 to rotate, and at the same time, convenience is provided for separation of the second connecting member 122 from the rotating part 130, and convenience is provided for maintenance.

Specifically, referring to FIG. 4 and FIG. 5, the second connecting part 131 is outwards and convexly provided with a key position 132 along the radial direction of the rotating part 130, a sidewall of the second plugging hole 1291 is provided with a key groove 1292 by extending outwards along the radial direction of the second connecting member 122, and the key position 132 matches with the key groove 1292, so that the second connecting member 122 can drive the rotating part 130 to rotate, at the same time, abnormal transmission between the imperceptible slipping device and the rotating part 130 due to errors is avoided, the rotating part 130 is avoided from offset during rotation, the rotating stability of the rotating part 130 is improved, the rotation life of the rotating part 130 is prolonged, and meanwhile a coupler is replaced, thereby reducing the volume and saving the space.

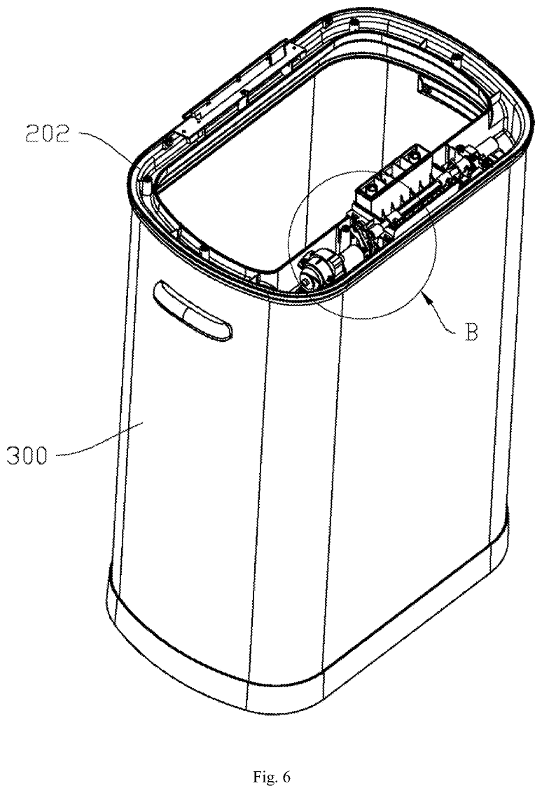

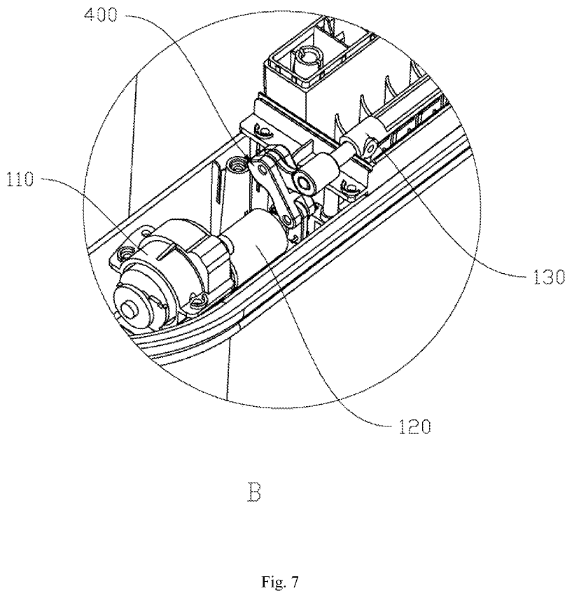

In addition, it can be understood that, in other embodiments, referring to FIG. 6 and FIG. 7, a connecting rod component 400 is arranged between the imperceptible slipping device and the rotating part 130, so that the imperceptible slipping device drives the rotating part 130 to rotate by means of the connecting rod component 400, thus space arrangement of the driving manner is more flexible and more convenient, the adaption range is widened, and practicality is improved.

The embodiments of the present disclosure are described in detail above in combination with the drawings, however the present disclosure is not limited to the above embodiments. Within the scope of knowledge possessed by the ordinary skilled in the art, various changes can be made without departing from the purpose of the present disclosure.

What is claimed is:

1. An imperceptible slipping device, comprising:
a first connecting member connected with an output shaft of a motor, wherein the first connecting member is convexly provided with a first connecting part, and an outer side of the first connecting part is provided with an abutting member; and
a second connecting member connected with a rotating part, wherein the second connecting member is provided with a first plugging hole for accommodating the first connecting part, the first connecting part is plugged into the first plugging hole, and the abutting member is in interference fit with the first plugging hole.

2. The imperceptible slipping device of claim 1, wherein an outer side of the first connecting part is provided with a positioning groove along a circumferential direction, and the abutting member is sleeved within the positioning groove.

3. The imperceptible slipping device of claim 1, wherein the first connecting part is provided with a positioning hole at one end towards the first plugging hole, a positioning column is arranged in the first plugging hole, and the positioning column is in plugging fit with the positioning hole.

4. The imperceptible slipping device of claim 3, wherein the positioning hole is provided with a first guiding part at one end towards the second connecting member, the positioning column is provided with a second guiding part at one end towards the first connecting member, and the first guiding part matches with the second guiding part, so that the positioning column is guided into the positioning hole.

5. The imperceptible slipping device of claim 1, wherein the first connecting member is outwards and convexly provided with a positioning part along a radial direction, and the positioning part abuts against the second connecting member.

6. The imperceptible slipping device of claim 5, wherein an outer edge of the positioning part is flush with that of the second connecting member.

7. A trashcan, comprising an imperceptible slipping device, the imperceptible slipping device comprising:
a first connecting member connected with an output shaft of a motor, wherein the first connecting member is convexly provided with a first connecting part, and an outer side of the first connecting part is provided with an abutting member; and
a second connecting member connected with a rotating part, wherein the second connecting member is provided with a first plugging hole for accommodating the first connecting part, the first connecting part is plugged into the first plugging hole, and the abutting member is in interference fit with the first plugging hole.

8. The trashcan of claim 7, wherein the trashcan further comprises an upper cover component and a barrel body, the upper cover component comprises a motor component, a cover body and a mounting body, the motor component and the rotating part are both arranged in the mounting body, the cover body is connected with the rotating part, an output shaft of the motor component is connected with the first connecting member, and the rotating part is connected with the second connecting member.

9. The trashcan of claim 8, wherein the second connecting member is provided with a second plugging hole along an axial direction of the second connecting member at one end towards the rotating part, the rotating part is provided with a second connecting part which matches with the second plugging hole, and the second connecting part is plugged with the second plugging hole, so that the second connecting member is capable of driving the rotating part to rotate.

10. The trashcan of claim 9, wherein the second connecting part is outwards and convexly provided with a key position along a radial direction of the rotating part, a sidewall of the second plugging hole is provided with a key groove by extending outwards along a radial direction of the second connecting member, and the key position matches with the key groove.
